(19) United States
(12) Patent Application Publication
(10) Pub. No.: US 2021/0370886 A1
(43) Pub. Date: Dec. 2, 2021

(54) VEHICLE MONITOR CLEARING DEVICE

(71) Applicant: Mickey Martin, Apex, NC (US)

(72) Inventor: Mickey Martin, Apex, NC (US)

(21) Appl. No.: 16/886,879

(22) Filed: May 29, 2020

(51) Int. Cl. B60S 1/56; B60S 1/08; B60S 1/66

(52) U.S. Cl. CPC B60S 1/56; B60S 1/66; B60S 1/0848

(57) ABSTRACT

A vehicle monitor clearing system includes an air source for generating an air flow at a desired pressure. A channel is connected to the air source. The channel receives the air flow from the air source and delivers it to at least one nozzle connected to the channel. The system further includes at least one nozzle for discharging the air flow toward a vehicle monitor located proximate to the nozzle. The system operates by applying forced air at the vehicle monitor, clearing road spray accumulated on a surface of the vehicle monitor.

### BACKGROUND

The present disclosure is directed to a vehicle monitor clearing device and method for removing road spray from a vehicle monitor using forced air. It finds particular application in conjunction with vehicle cameras and sensors and will be described with particular reference thereto. However, it is to be appreciated that the present exemplary embodiment is also amenable to other like applications.

Back-up cameras and similar technologies were first incorporated in vehicles as a high-end amenity. However, shortly after their introduction, growing safety concerns made them a standard feature in all newly manufactured vehicles. Now, regulations in some countries require that all vehicles be equipped with backup or additional cameras that provide views of the surrounding environment.

The camera field-of-view is displayed in real time on a display screen located in the vehicle. In certain vehicles, the camera field-of-view is automatically displayed when the vehicle is in reverse gear. This feature allows the driver to see objects behind the vehicle. However, these camera systems suffer from limitations when road spray (or water droplets or debris (dust and dirt, etc.)) accumulates on the camera lens. Road spray can cover the camera lens during rain and snow or when ground conditions are muddy. This obstructs, if not altogether blocks, the image displayed on the screen.

Such conditions necessitate that a person (likely from inside the cabin) manually (i.e., wipe) clear the monitor when the need is immediate, such as for example, to prevent damage to the vehicle. This creates an inconvenience, if not a hazard. For most vehicles, the camera is cleaned the next time the driver washes the vehicle. Some higher-end vehicles employ washer fluid to remove road spray from the camera lens. These vehicles automatically discharge washer fluid when predetermined conditions are met. However, without an accompanying wiper blade, the washer fluid leaves liquid droplets on the camera lens that continues to obstruct the view.

Thus, a vehicle monitor clearing device is desired which can remove road spray and the like without using a liquid. A vehicle monitor clearing system is desired which can be retrofitted to existing vehicles or incorporated in newly manufactured vehicles.

### BRIEF DESCRIPTION

One embodiment of the present disclosure relates to a vehicle monitor clearing system. The system includes an air source for generating an air flow at a desired pressure. The system further includes a channel connected to the air source. The channel receives the air flow from the air source and delivers it to at least one nozzle connected to the channel. The system further includes at least one nozzle for discharging the air flow toward a vehicle monitor located proximate to the nozzle. The system uses forced air to clear road spray accumulated on a surface of the vehicle monitor.

Another embodiment of the present disclosure relates to a kit. The kit includes an air source for securing in a body compartment of a vehicle. The air source is operative to generate an air flow at a desired pressure. The kit further includes a nozzle for securing proximate to a monitor on the vehicle. The nozzle is operative to discharge the air flow at the monitor. The kit further includes a channel connecting the air source to the nozzle. The channel is for extending along a void in a body of the vehicle. The channel is operative to carry the air flow from the air source to the nozzle. Installed, the parts of the kit can apply forced air at the monitor to clear road spray accumulated on a surface of the monitor.

A further embodiment of the present disclosure is directed to a method for clearing road spray from a vehicle monitor. The method includes the step of providing an air source with a vehicle. The air source is operative for generating an air flow at a desired pressure. The method also includes the step of securing a nozzle proximate to a monitor on the vehicle. The nozzle is operative for discharging the air flow at the monitor. The air source and the nozzle are connected by a channel that carries the air from the air source to the nozzle. The method additionally includes the step of connecting the air source to a power supply in the vehicle. The method also includes the step of activating the air source to apply forced air at the monitor.

### BRIEF DESCRIPTION OF THE DRAWINGS

For a more complete understanding of the disclosure, reference is now made to the embodiments illustrated in greater detail in the accompanying drawings and described below by way of examples of the disclosure.

FIG. 1 is a schematic view of a vehicle equipped with an existing vehicle monitoring system.

FIG. 2 is a schematic view of a vehicle equipped with an example vehicle monitor clearing device according to one embodiment of the disclosure.

FIGS. 3A-3B are example circuit diagrams for different embodiments of the vehicle monitor clearing device.

FIG. 4 is a partial rear perspective view of the vehicle of FIG. 2 including the clearing device mounted to the vehicle.

FIG. 5A is a sample before image displayed on a dashboard screen before an operation of an example vehicle monitor clearing device of the present disclosure.

FIG. 5B is a sample after image displayed on a dashboard screen after an operation of the example vehicle monitor clearing device of the present disclosure.

### DETAILED DESCRIPTION

The present disclosure is directed to a vehicle monitor clearing device (“clearing device”) that uses forced air to clear accumulated matter from a surface of a monitor. In one example, the clearing device employs a forced airstream that it discharges in a predetermined direction, which in certain embodiments is toward the exposed surface of an exterior monitor on a vehicle. The clearing device includes a fluid source, a nozzle, and a closed delivery channel connecting the fluid source to the nozzle. The nozzle head is contemplated for placement in proximity to the monitor. The clearing device is operative to discharge the fluid at a select pressure (or range) that is sufficiently high enough to remove road spray from the surface of the monitor and low enough to not damage the monitor.

As used herein, the term “road spray” can mean any wet or dry foreign matter that accumulates on or covers the monitor. In certain embodiments, road spray is a mixture of water (rain or snow) and particles (e.g., dirt) that falls on or has been kicked up or sprayed onto the vehicle monitor. It can include rain, snow, water, slush, dirt, mud, dust, debris, oil, etc. that sticks to the monitor surface. It can refer to wet matter in the form of droplets or mud or dry matter, such as dirt.

As used herein, the term “monitor” can mean a camera, camera lens or sensor that is operative to capture an input and transmit the input data to a vehicle CPU in communication with the monitor. In one example, the monitor can be a camera that takes an image and transmits the captured image data to the vehicle CPU. In another example, the monitor can be a sensor that takes a measurement and transmits a signal of the measurement to the vehicle CPU. The captured image data or signal (collectively “input”) undergoes processing at the CPU to generate an output that is indicative of the vehicle's surrounding environment. The indicator (“output”) can be, for example, a visual output (e.g., video or still image frames, etc.), an audio output (e.g., alarm), a digital output including a graphical signal (e.g., warning light), or the like.

As used herein, the term “image” can refer to a video of one or more frames or to a still image(s). An output image can refer to a real-time video stream or a virtual viewpoint in a simulated environment. There is no limitation made herein to the way an output is displayed. The disclosure contemplates a real-time video stream that displays on a screen inside the cabin of the vehicle on which the monitor is incorporated. This screen can be a dashboard display; a heads-up display; or a phone or touchscreen on a portable computing device connected (via wired or wireless connection) to the vehicle. The screen or device from which the indicator is provided as output is also in communication with the vehicle CPU.

As used herein, a “vehicle” may be a passenger car or any other suitable vehicle. For example, the vehicle may be a motorcycle, truck, sports utility vehicle (SUV), van, recreational vehicle, commercial vehicle, marine vessel, aircraft, or the like that includes a monitor and a forced air clearing system.

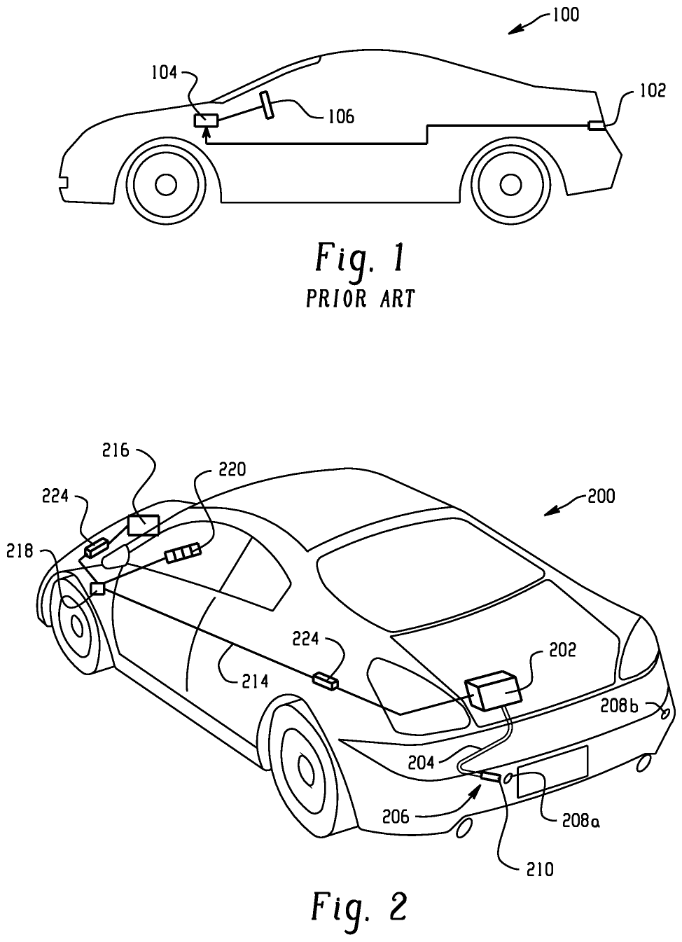

One embodiment of the disclosed clearing device is adapted for retrofit in existing vehicle monitor systems. FIG. 1 is a schematic diagram of a vehicle equipped with a monitor system in the PRIOR ART. The vehicle 100 includes a monitor 102 that detects objects or other vehicles proximate to the vehicle 100. The information and data collected by the monitor 102 is communicated to a controller 104, which processes and presents the data on a display or screen 106 inside the cabin of the vehicle (or outside the vehicle within the peripheral view of an operator). The controller is a microprocessor-based controller having associated inputs, outputs, a communication bus and memory such as RAM and ROM. The controller may be a stand-alone controller independent from, or in communication with, the vehicle's engine control module or it may be integrated therewith. The display 106 is a screen-based display or any other known display mechanism that is operable to present the signal information collected by the monitor.

In the illustrated embodiment, the monitor can be a camera (e.g., video camera) that captures objects within the camera field-of-view. It can be mounted anywhere on the vehicle, but in the discussed embodiment the monitor is mounted at the rear bumper of the vehicle for illustrative purposes. Alternatively, the monitor can be a blind spot monitor. Blind spot monitors use electronic detection (e.g., cameras, radar-based detectors, sensors, etc.) to detect objects behind and to the side of the vehicle. They can be mounted in the vicinity of the external side mirrors or at the corner of the rear wing or bumper. An alarm or warning (e.g., light) is generated when an object is detected in the monitor field-of-view.
I. The System

In one embodiment, an example clearing device is contemplated for use with the existing monitor system of FIG. 1. FIG. 2 is a schematic diagram of a vehicle equipped with a forced air clearing system 200 according to one embodiment of the present disclosure. While air is the fluid employed in the illustrated embodiment, there is no limitation made to the fluid selected for the system. The present disclosure is amenable to like embodiments of a forced fluid clearing system. In these additional embodiments, an alternative gas, liquid, or solution can be employed with the components of the system. In such embodiments, the various components of the clearing system are selected to enable an operation with the alternative fluid.

One aspect of using forced air in the present disclosure is that it avoids a consumable product. Existing camera cleaning systems employ washer fluid. These require an operator of the vehicle to refill a tank—stored in the vehicle—each time the washer fluid is low. They may further necessitate an additional sensor, for measuring the washer fluid level, or an additional obligation on the operator, when a sensor is absent. By using forced air, the present disclosure eliminates the time required by operators to repeatedly refill the washer fluid; eliminates the added costs associated with a consumable such as washer fluid; and eliminates the additional components, such as sensors, covers or wiper blades, all of which require specialized circuitry to operate and, thus, can malfunction.

Returning to FIG. 2, the system 200 includes an air source 202, which is a source of pressurized air. In one example, the air source 202 is an air pump. The pump is operative to discharge air at a desired pressure sufficiently high enough to remove approximately one inch of mud caked and/or dried on the exposed exterior surface of the monitor, but low enough to not damage or dislocate the monitor. The system 200 further includes a closed channel 204 (tube or hose) defined by a continuous side wall. There is no limitation on a material that the channel is formed from as long as it is made of a material that provides the desired structural (e.g., flexible, rigid, etc.) properties. At one end of the channel 204 is an air intake hole for receiving air from the air 202. At the other end of the channel 204 is a nozzle 206. The nozzle 206 allows air pressure to be discharged from the channel 204 toward the monitor 208a. The nozzle 206 includes a nozzle head 210 that enables placement of the nozzle 206 in front of the monitor 208a when the channel 204 may be behind the surface of the monitor. In one example, the nozzle 206 can be a flexible (neck) that can bend and be manipulated to allow for the nozzle head 210 to be placed as desired by the operator. When powered, the air source 202 is adapted to provide a continuous air stream to the channel. However, other embodiments are contemplated from which a pulsed air stream is provided, or from which a combination of both continuous and pulsed airstreams are provided.

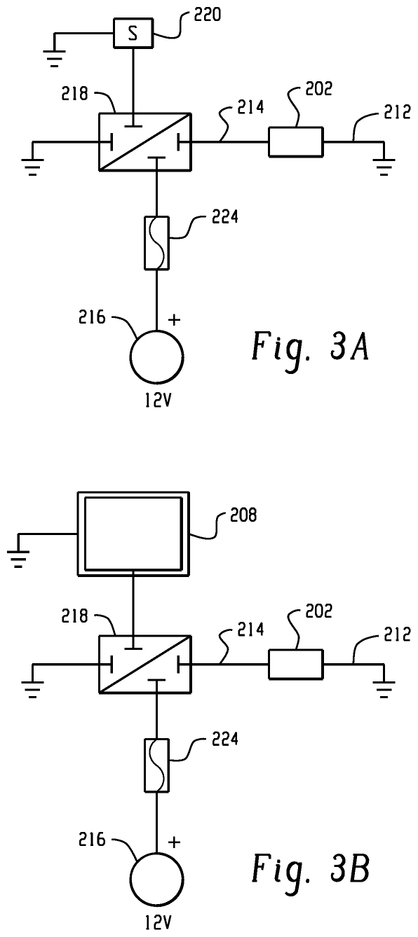

Continuing with FIG. 2, the system 200 includes a set of wires or power lines 212, 214. In one example, each wire 212, 214 is at one end in fixed attachment to the air source 202. In another embodiment, the wires 212, 214 are removeably attached to the air source 202. A first power line 212 (FIGS. 3A and 3B) is operative to carry current to a ground connection, such as a body ground on the vehicle. The second (positive) power line 214 is operative to connect the air source 202 to a power supply 216, which may be in one example existing in the vehicle. In one embodiment, the positive cable 214 can be connected directly to the positive on the vehicle battery. In such embodiment, the positive power line 214 can be fused.

In a different embodiment, the positive power line 214 can be connected to (e.g., the 87-post on) a relay 218 that is powered by the power supply 216. In one embodiment, which can be in the form of a kit, the system 200 can include the relay.

In a contemplated embodiment, the positive power line 214 can be connected to (e.g., the 87-post on) a relay 218 to an existing auxiliary switch 220 inside the cabin. This allows the operator of the vehicle to selectively control the discharge of air flow from inside the cabin. The relay 218 is also connected to the power supply 216. FIG. 3A is an example circuit diagram for operating a vehicle monitor clearing device in which the positive power line is connected to a relay of an existing auxiliary switch.

In another embodiment, the relay can be an existing relay from which an existing feature of the vehicle is powered. In other contemplated embodiments, the relay can be a relay to an existing monitor 208 (or monitoring system) (see FIG. 3B), such as a back-up camera; a relay to back-up lights; or a relay to a shift. In such embodiments where the positive power line is connected to a relay to an existing back-up camera (or other environmental camera), it is contemplated that the air source is activated when the monitor is on and, more specifically, when the camera field of view is being displayed inside the vehicle. Depending on the vehicle, the monitor may automatically go on when the vehicle is in reverse, or it may selectively turn on when the operator activates a control inside the cabin. To activate the air source automatically in other embodiments, the positive power line can be connected to a relay to the back-up lights or the shift. It is contemplated that the air source is activated when the back-up lights go on or when the vehicle is in reverse gear, respectively.

Additional operations are contemplated in which the system is adapted for incorporation in a 5-post relay or, in vehicles in which a 5-post relay is absent, the system can include a 5-post relay. In such embodiments, for example, the positive power line 214 can connect to a relay to the back-up lights and the camera, where both the camera and the air source activate when the back-up lights are on; or the positive power line 214 can connect to a relay to the monitor and a shift, where both the monitor and the air source operate when the vehicle is in reverse. There is no limitation made herein to the assembly of the clearing system to existing circuitry of the vehicle; the cables are contemplated for connection to such circuitry.

In one example, the lines 212, 214 are of sufficient length to run along the entire length or body of the vehicle. By “sufficient length”, the disclosure contemplates a wire that is long enough to attach at one end to an air source located in a rear portion (e.g., trunk) of the vehicle and connect at another end to a relay or power supply located in a front portion (e.g., in the engine bay) of the vehicle.

Returning to FIG. 2, the clearing system 200 further includes mechanical fasteners (not shown), such as, for example, a bracket and screws; nuts, bolts, washers, plugs and/or bushings; and the like. There is no limitation to the type of mounting mechanism employed in the system 200; however, in the contemplated embodiment, the body of the air source 202 can include a mounting apparatus that allows it to be securely mounted to the vehicle while allowing the air source to sufficiently absorb or withstand vibrations that occur when the vehicle is moving. In one example, the air source 202 can include a bracket on or extending from the body of the air source. In another example, the air source 202 can include mounting holes aligned along a body portion of the air source. Holes in the bracket, or mounting holes in the body of the air source 202, can align with holes available (or made available) in the vehicle rail. Nuts can be fastened to bolts for securing the air source 202 and vehicle rail components together. In another example, the clearing system can include a magnet fixed to the air source and operative to removeably mount the air source to a body rail of a vehicle, such a rigid rail portion located in a trunk. In further embodiments, the air source can be defined by a profile that enables an interference fit inside a recess of the vehicle body cavity.

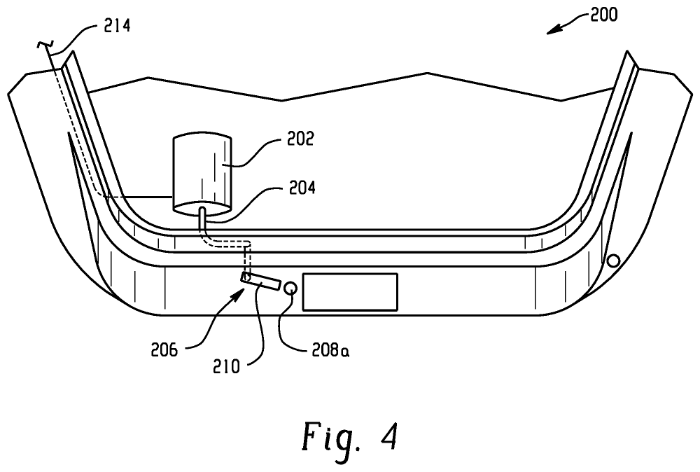

FIG. 4 illustrates an example air source 202 mounted in the trunk of a vehicle. For applying forced air at a monitor located on a rear bumper of a vehicle, the air source 202 can be security fit inside a recess, or to a rail, located in the trunk or rear end portion of the vehicle. From the air source 202, the channel 204 can extend from the air source, along the inside wall of the body, the undercarriage, or the frame, to the monitor. In the illustrated system, the clearing system 200 is adapted for retrofit in an existing vehicle.

However, other embodiments of the system are contemplated in which the clearing device or system 200 is incorporated into newly manufactured vehicles. In such embodiments, the air source 202 can be built into to vehicle along with the other components of the system 200. In certain embodiments, the nozzle head 210 can be included with the monitor as single unit, and the unit installed in the vehicle during its manufacture.

In other embodiments, the system 200 can be included with, or incorporated into, off-the-shelf camera systems that are installed in vehicles after manufacture.

In yet another embodiment, the channel 204—connecting to the air source 202—can bifurcate into at least a second branch (that creates a second channel portion 224 (not shown)). The air source 202 can pump air into the air intake end of the channel 204, where it is jetted out through the different branches. Each branch can terminate at a nozzle, which forces air onto a monitor or sensor. In this manner, a single air source 202 can clear the road spray accumulated on multiple monitors (e.g., a camera 208a and radar detector 208b, etc.) installed in the same region (e.g., rear bumper) of the vehicle.
II. In Operation

In operation, the present disclosure is adapted for incorporation in multiple environments. While embodiments are contemplated in which the disclosed clearing system 200 is incorporated in newly manufactured vehicles, the installation is described for a clearing device that can be retrofit onto a vehicle.

A monitor clearing kit includes at least an air source 202 for pumping air into a channel; a channel 204 for delivering air to a nozzle head; and a nozzle head 210 for discharging air onto a monitor. The kit further includes at least a set of power lines 212, 214 adapted to connect to a power supply and ground connection.

To install the system, the air source 202 can be first secured to the vehicle. In one embodiment, the air source 202 can be mounted in the body compartment located in the trunk. Most vehicle types have a concealed area (e.g., a wheel well) (hereinafter referred to as “recess”) in the storage compartment (e.g., trunk) that is accessible to operators via an exposed panel. The recess may or may not be the same compartment that stores a spare tire and other concealed items. In some embodiments, the air source 202 can be secured in the recess using an interference fit created by the space surrounding the air source when the panel is replaced. In other embodiments, the air source 202 can be secured to the recess using the mechanical fasteners (not shown) or the like. By securing the air source 202 inside the recess, the air source and the entire clearing system 200 can be concealed from view when the panel is placed back into position. For certain vehicle types, e.g., pick-up trucks or vehicles with beds, the air source 202 can be installed on a frame rail using the mechanical fasteners.

Next, the channel 204 is run to at least one monitor 208 located within reach of the channel. The channel 204 can follow existing wires for camera, sensors, and/or lights. In another example, the channel can run along the undercarriage or frame of the vehicle. The nozzle neck 210 is fed through a small hole drilled in the plastic monitor housing or the body of the vehicle. In some embodiments the nozzle head 210 is fixedly attached to the neck 206 and can be fed through the drilled hole. In other embodiments, the neck 206 is of smaller diameter than the nozzle head 210 and can be attached to the neck after the neck is fed through the hole.

In operation, the nozzle head 210 can be situated on the exterior of the vehicle such that the nozzle head 210 generally faces the monitor and, in one embodiment, can be angled slightly skewed toward the monitor to discharge an airstream that simultaneously drives the droplets and road spray away from the monitor. The nozzle head 210 is situated in such a manner that the airstream appropriately moves a thick layer of accumulation. In embodiments (not shown) where the channel bifurcates into multiple branches, each branch can be run to a monitor and installed in similar manner.

Next, power to the air source 202 must be established using the power lines 212, 214. The first power line 212 is connected to a body ground of the vehicle. After the air source 202 is grounded, the second power line 214 is connected to the power supply 216. The positive power line 214 can be run to the local fuse panel, or it can be run to a fuse panel in the engine bay. The connection to the power supply 216 varies depending on desired (automatic or selected) control airstream. The wiring and connections are maintained outside the cabin.
A. Selected Control

In one example, the forced air can be selectively discharged using an existing auxiliary switch 220 inside the cabin of the vehicle. In such embodiments, the operator controls when the forced air is discharged from the clearing device by activating a switch 220 on a dashboard panel.

With reference to FIG. 3A, to accomplish this, the positive power line 214 (coming from the air source) can be run to and connected with relay 218 to the auxiliary switch 220. The positive line 214 can be connected to the 87-post in the 4- or 5-post relay 218. In such embodiment, the relay 218 controls the switch 220 (which runs on lower voltage) inside the cabin of the vehicle. A remote wire runs from the 86-post of the same relay to the auxiliary switch 220 inside the cabin.

To power the relay 218 (i.e., to power the air source 202), the relay is connected to the power supply 210 using a fused line that goes directly to the power supply. Another line from the relay 218 is connected to ground.

In this manner, when the operator of the vehicle selects (e.g., presses) the auxiliary switch inside the vehicle, the auxiliary line operates the electrical magnet to the relay that turns the air source on (by delivering power to the air source).
B. Automatic Control

In another example, the forced air can be automatically discharged when specific conditions are met. For example, the forced air can be automatically discharged when the vehicle is in reverse.

With reference to FIG. 3B, to accomplish this, the positive power line 214 (coming from the air source 202) can be run to and connected with the relay 218 to another feature, such as the back-up lights, the shift, or the monitor 208. The positive line 214 can be connected to the 87-post in the 4- or 5-post relay 218. In such embodiment, the relay controls the other feature (e.g., the monitor 208 in FIG. 3B). A remote wire runs from the 86-post of the same relay 218 to the feature.

To power the relay 218 (i.e., to power the air source 202), the relay is connected to the power supply 216 using a fused line (see fuse 224) that goes directly to the power supply. Another line from the relay is connected to ground.

In this manner, when the operator puts the vehicle in reverse gear, the relay activates the air source (by delivering power to the air source) while the other feature is activated.

Additionally, for purposes of simplicity, although the method for installing the clearing system 200 is described as being executed serially, it is to be understood and appreciated that the present disclosure is not limited by the illustrated order as some steps could occur in different orders and/or concurrently with other steps shown and described herein. Moreover, not all illustrated aspects may be required to implement the system.

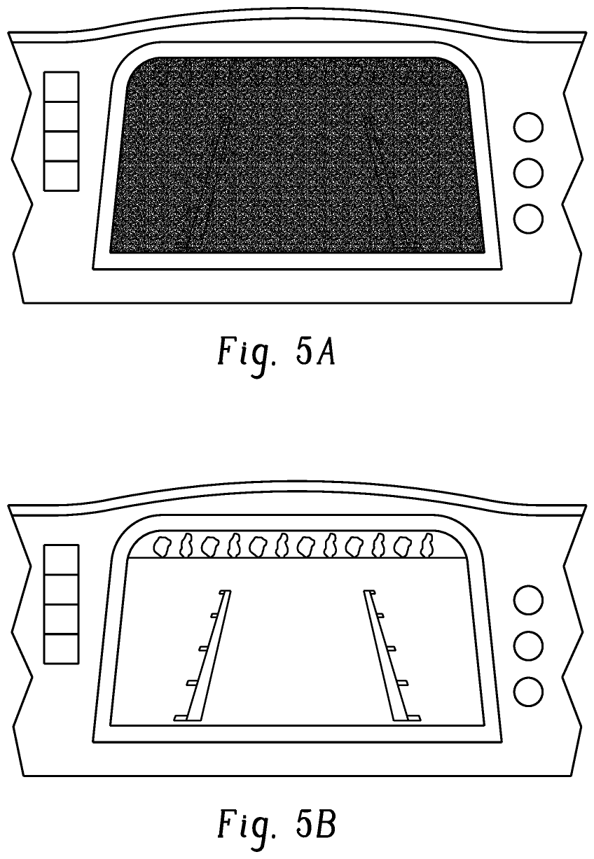

FIG. 5A is a sample image displayed on a dashboard screen before an operation of an example vehicle monitor clearing device of the present disclosure. In this example, a layer of mud and dried road spray is accumulated on the monitor (camera). Therefore, the image frame shown inside the cabin is obscured by the mud in the foreground. Although not shown in the sample image, foreign matter as simple as water droplets can also blur the image or view seen by the operator.

FIG. 5B is a sample image displayed on a dashboard screen of FIG. 5A after an operation of the example vehicle monitor clearing device of the present disclosure. The application of forced air onto the monitor removes matter from the monitor and restores the view. One aspect of the present clearing device is that it also removes water droplets from the surface of the monitor. The clearing device can therefore dry a wet monitor. Therefore, the present disclosure improves on existing washer fluid-based systems that may clean a monitor but leave behind conditions that create a suboptimal output.

Although the operation is described in operation with a vehicle camera, it is to be understood that a camera monitor (and the resulting image frame output) is disclosed for illustrative purposes only. In another embodiment, the nozzle head of the clearing system can be placed in proximity of a blind spot monitoring system. Blind spot monitors use electronic detection (e.g., cameras, radar-based detectors, sensors, eta) to detect objects behind and to the side of the vehicle. They can be mounted in the vicinity of the external side mirrors or at the corner of the rear wing or bumper. An alarm or warning (e.g., blinking light) is generated when an object is detected in the monitor field-of-view.

Blind spot monitors, however, can malfunction if the monitor is not clean. This is particularly problematic in wet and snowy conditions because water—on the surface of the monitor—can generate continuous false warnings. By forcing air onto the monitor, the disclosed clearing device can remove any water droplets or ice that causes the false warning. Therefore, the present disclosure can be incorporated into use with any feature that detects the vehicular environment or surroundings.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A vehicle monitor clearing device, comprising:
an air source, the air source for generating an air flow at a desired pressure;
a channel connected to the air source, the channel for receiving the air flow from the air source; and,
at least one nozzle connected to the channel, the nozzle for discharging the air flow toward an associated vehicle monitor located proximate to the nozzle.
wherein the system uses forced air to clear road spray accumulated on a surface of the vehicle monitor.

2. The system of claim 1, wherein the forced air is a continuous airstream.

3. The system of claim 1, wherein the forced air is a pulsed airstream.

4. The system of claim 1, wherein the air source is independently and selectively activated by a switch.

5. The system of claim 1, wherein the air source is automatically activated when the associated vehicle monitor is active.

6. The system of claim 1, wherein the system does not use a liquid fluid.

7. The system of claim 1, wherein the monitor is selected from a vehicle back-up camera and a blind spot monitor.

8. The system of claim 1 further comprising:
a power line to connect the air source to a power supply.

9. The system of claim 1, wherein the air source includes a mechanical mounting component on a body of the air source, the mechanical mounting component for securing the air source to an associated vehicle body.

10. A kit, comprising:
an air source for securing in a body compartment of a vehicle, the air source for generating an air flow at a desired pressure;
a nozzle for securing proximate a monitor on a vehicle, the nozzle for discharging the air flow at the monitor;
a channel for extending along a void in a body of the vehicle, the channel for carrying the air flow to the nozzle;
wherein the nozzle applies forced air at the monitor to clear road spray accumulated on a surface of the monitor.

11. The kit of claim 10, wherein the forced air is one of a continuous and pulsed airstream.

12. The kit of claim 10 further comprising:
a power line for connecting the air source to a power supply.

13. The kit of claim 12, wherein the power supply is a relay to an auxiliary switch in the vehicle, wherein the air source is independently and selectively activated by the switch.

14. The kit of claim 12, wherein the power supply is a relay to the monitor, wherein the air source is automatically activated when the monitor is active.

15. The kit of claim 12, wherein the power supply is a relay to the back-up lights, wherein the air source is automatically activated when the back-up lights are on.

16. The kit of claim 12, wherein the power supply is a relay to the shift, wherein the air source is automatically activated when the shift is in reverse gear.

17. The kit of claim 10, wherein the kit is for retrofit into a vehicle.

18. The kit of claim 10, wherein the monitor is selected from a vehicle back-up camera and a blind spot monitor.

19. The kit of claim 10 further comprising:
mechanical fasteners for mounting the air source to the vehicle.

20. A method for clearing road spray from a vehicle monitor, the method comprising:
providing an air source with a vehicle, the air source for generating an air flow at a desired pressure;
securing a nozzle proximate a monitor on the vehicle, the nozzle for discharging the air flow at the monitor, the air source and the nozzle being connected by a channel; and,
connecting the air source to a power supply in the vehicle; and,
activating the air source to apply forced air at the monitor.
